(19) United States
(12) Patent Application Publication
(10) Pub. No.: US 2023/0256648 A1
(43) Pub. Date: Aug. 17, 2023

(54) METHOD OF MANUFACTURING A FIRE-RETARDANT TREATED WOOD COMPOSITE PANEL

(71) Applicant: LOUISIANA-PACIFIC CORPORATION, NASHVILLE, TN (US)

(72) Inventors: JIANWEN NI, FRANKLIN, TN (US); JEFF YELLE, HENDERSONVILLE, TN (US)

(21) Appl. No.: 18/109,036

(22) Filed: Feb. 13, 2023

Related U.S. Application Data
(60) Provisional application No. 63/309,568, filed on Feb. 13, 2022.
(60) Provisional application No. 63/324,105, filed on Mar. 27, 2022.
(60) Provisional application No. 63/326,168, filed on Mar. 31, 2022.

(51) Int. Cl. B27N 9/00; C09K 21/02; C08L 97/02; C08K 3/38; B27N 3/04; B27N 3/06; B27N 1/02; B27N 3/18; B32B 37/10; B32B 37/24; B32B 21/02; B32B 21/06

(52) U.S. Cl. CPC B27N 9/00; B27N 1/02; B27N 3/04; B27N 3/06; B27N 3/18; B32B 21/02; B32B 21/06; B32B 37/10; B32B 37/24; C08K 3/38; C08L 97/02; C09K 21/02; B32B 2305/28; B32B 2307/3065; B32B 2309/02; C08K 2003/387; C08L 2201/02; C08L 2205/16

(57) ABSTRACT

Methods of manufacturing a fire-retardant treated OSB to avoid press build-up issues with prior art fire retardants such as boric acid when subjected to normal heat and pressure used in forming an OSB panel. In one embodiment, the press temperature is reduced to below the melting point or softening temperature of the boric acid and/or prior art fire retardants, with a fast-cure adhesive system used in the mat to provide sufficient bonding and integrity while using a lower press temperature. Alternatively, a zinc borate or calcium borate dispersion, with melting points higher than normal press temperatures, is applied to the wood strands prior to pressing. The zinc borate and/or calcium borate are not melted or softened during the OSB manufacturing process, thereby avoiding the press build-up issues with boric acid.

This application claims benefit of and priority to U.S. Provisional Applications No. 63/309,568, filed Feb. 13, 2022, No. 63/324,105, filed Mar. 27, 2022, and No. 63/326,168, filed Mar. 31, 2022, all of which are incorporated herein in their entireties by specific reference for all purposes.

### FIELD OF INVENTION

This invention relates to a process of manufacturing a fire-retardant treated wood composite panel, such as oriented strand board (OSB), particleboard, medium density fiberboard (MDF), or other cellulose-based panels.

### BACKGROUND OF THE INVENTION

In general, wood-based composites include, but are not limited to, oriented strand board (OSB), wafer board, flake board, particleboard, and fiberboard (e.g., medium density fiberboard, or MDF). These wood-based composites are typically formed from a wood element (e.g., flake, strand, particle, wafer) combined with a thermosetting adhesive to bind the wood substrate together. In some processes, other additives are added to impart additional properties to the wood composites. Additives may include fire retardants, fungicides, mildew-cides, insecticides, and water repellents. A significant advantage of strand and particle-based wood composites is that they have many of the properties of plywood and dimensional lumber, but can be made from a variety of lower grade wood species, smaller trees and waste from other wood product processing. In addition, they can be formed into panels in lengths and widths independent of the size of the harvested timber.

One class of wood-based composites products comprise multilayer, oriented wood strand panel products. These oriented-strand, multilayer composite wood panel products are composed of several layers of thin wood strands, which are wood particles having a length which is several times greater than their width. These strands are created from debarked round logs by placing the edge of a cutting knife parallel to a length of the log and then slicing thin strands from the log. The result is a strand in which the fiber elements are substantially parallel to the strand length. These strands can then be oriented on a mat-forming line with the strands of the outer face layers predominantly oriented in a parallel-to-machine direction, and strands in the core layer generally oriented perpendicular to the face layers (i.e., “cross-machine”) direction.

In one known commercial process, these mat layers are bonded together using natural or synthetic adhesive resins under heat and pressure to make the finished product. Oriented, multilayer wood strand panels of the above-described type can be produced with mechanical and physical properties comparable to those of commercial softwood plywood and are used interchangeably, such as for wall and roof sheathing. In certain types of construction, these wood-based panels (and other construction materials) may be required by building codes to meet certain durability requirements, such as fire, wind and water resistance.

Oriented, multilayer wood strand panels and similar products of the above-described type, and examples of processes for pressing and production thereof, are described in detail in US. Pat. No. 3,164,511, US. Pat. No. 4,364,984, US. Pat. No. 5,435,976, US. Pat. No. 5,470,631, US. Pat. No. 5,525,394, US. Pat. No. 5,718,786, and US Pat. No. 6,461,743, all of which are incorporated herein in their entireties by specific reference for all purposes.

Some wood panel products (e.g., fire-retardant treated plywood) are treated with fire retardants, which are activated and catalyze the dehydration of cellulose when exposed to heat during a fire event. This reaction converts wood into water and “char” (i.e., partially-burned wood or charcoal), and reduces the susceptibility of the wood to continuous combustion.

While effective for imparting fire retardancy to wood, these fire retardants may be susceptible to premature activation. For example, some fire retardants could be activated under the high heat and high humidity in an attic space during summer, which would degrade the mechanical strength of wood structural panels. Various fire-retardant formulations have developed to address this issue. For, example, U.S. Pat. No. 4,373,010 (which is incorporated herein in its entirety by specific reference for all purposes) describes several liquid fire retardants that contain guanylurea phosphate (GUP) and boric acid. Similarly, U.S. Pat. No. 10,703,009 (which is incorporated herein in its entirety by specific reference for all purposes) describes an aqueous boric acid dispersion.

These fire retardants, however, will not properly work with wood-based panels, such as OSB, due to the high temperatures of the press during the manufacturing process. OSB typically is manufactured using press temperatures ranging from approximately 190° C. to approximately 220° C. Boric acid has a melting point of 170.9° C., which is below these press temperatures, so it will soften and melt while at higher temperatures, and its use during the OSB manufacturing process thus will result in build-up of the melted material in the press itself. Accordingly, OSB cannot be manufactured with these fire-retardant materials by currently-known processes.

### SUMMARY OF INVENTION

In various exemplary embodiments, the present invention comprises a process of manufacturing a fire-retardant treated OSB with low melting point fire retardant material. The present invention reduces the press temperature to below the melting point or softening temperature of the fire retardants noted above. To obtain an OSB panel with sufficient bonding and integrity while using a lower press temperature, the present invention in one embodiment applies a fast-cure adhesive system. In one exemplary embodiment, the fast-cure adhesive system comprises a 1-component adhesive with a latent catalyst/accelerator. In an alternative embodiment, an adhesive may be mixed in-line with an external catalyst or accelerator before being applied to the OSB strands prior to mat formation.

In other embodiments, the present invention applies a zinc borate or calcium borate dispersion to the wood strands prior to formation of a mat layer or a mat, and thus prior to application of heat and pressure in the press to form the composite panel. Zinc borate has a melting point of 1150° C., and calcium borate has a melting point of 986° C. These materials thus can be used with standard press temperatures (i.e., below 190 to 220° C.). The zinc borate and/or calcium borate are not melted or softened during the OSB manufacturing process, thereby avoiding the press build-up issues with boric acid.

### BRIEF DESCRIPTION OF THE DRAWINGS

FIG. 1 shows a cross section of an OSB panel product in accordance with the present invention.

FIG. 2 shows a diagram for a low temperature press production/manufacturing process for the OSB panel product of FIG. 1.

FIG. 3 shows a diagram for a standard (high) temperature press production/manufacturing process for the OSB panel product of FIG. 1.

FIG. 4 shows a diagram for a standard (high) temperature press production/manufacturing process with top and bottom overlays for the OSB panel product of FIG. 7.

FIG. 5 shows an example of wood fiber and fire-retardant buildup (on steel shims place on top of an OSB mat), with the OSB mat being pressed at a standard 212° C., for typical low melting-point FR materials.

FIG. 6 shows a lack of wood fiber and fire-retardant buildup on similar steel shims for an OSB mat being pressed in accordance with the low-temperature method of the present invention.

FIG. 7 shows a cross section of an OSB panel product in accordance with an alternative embodiment of the present invention.

### BRIEF DESCRIPTION OF INVENTION

In various exemplary embodiments, the present invention comprises a process of manufacturing a fire-retardant treated OSB with low melting point fire retardant material. The present invention reduces the press temperature to below the melting point or softening temperature of the fire retardants noted above. To obtain an OSB panel with sufficient bonding and integrity while using a lower press temperature, the present invention in one embodiment applies a fast-cure adhesive system. In one exemplary embodiment, the fast-cure adhesive system comprises a 1-component adhesive with a latent catalyst/accelerator. In an alternative embodiment, an adhesive may be mixed in-line with an external catalyst or accelerator before being applied to the OSB strands prior to mat formation.

In other embodiments, the present invention applies a zinc borate or calcium borate dispersion to the wood strands prior to formation of a mat layer or a mat, and thus prior to application of heat and pressure in the press to form the composite panel. Zinc borate has a melting point of 1150° C., and calcium borate has a melting point of 986° C. These materials thus can be used with standard press temperatures (i.e., from approximately 190° C. to approximately 220° C.). The zinc borate and/or calcium borate are not melted or softened during the OSB manufacturing process, thereby avoiding the press build-up issues with boric acid.

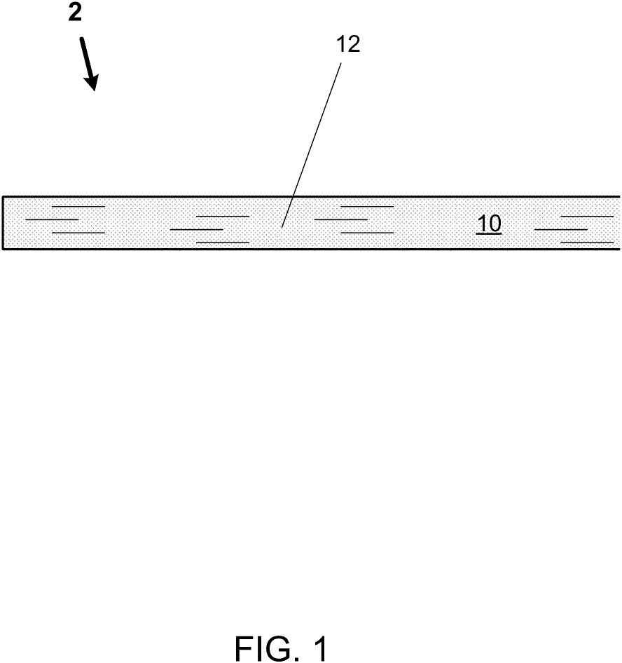

FIG. 1 shows a cross-section of a fire-resistant treated (FRT) panel in accordance with the present invention. The fire-resistant treatments described above thus are integrated with the material forming the FRT panel 2. The FRT panel provides structural performance and fire resistance characteristics for use in wall, floor, and roof applications that require a fire resistance performance, such as residential, single- or multi-family, and commercial construction. The FRT panel comprises a wood substrate 10, such as OSB, treated during the manufacturing process with a fire retardant 12 that provides fire resistance as described above. The treatment 12 thus is integrated with the material forming the wood structural panel 2 (e.g., blended with the flakes making up the mats for production of the OSB). The treatment may be blended with the material used for just one or more certain layers (e.g., top, bottom, core), or with the materials used for all of the layers. In some embodiments, the treatment 12 is dispersed through the wood substrate, but may be found at higher densities or concentrations in certain layers, or certain areas of a mat, or certain locations within the wood substrate as a whole. In additional embodiments, the treatment may be dispersed or spread more uniformly through a mat or the wood substrate as a whole.

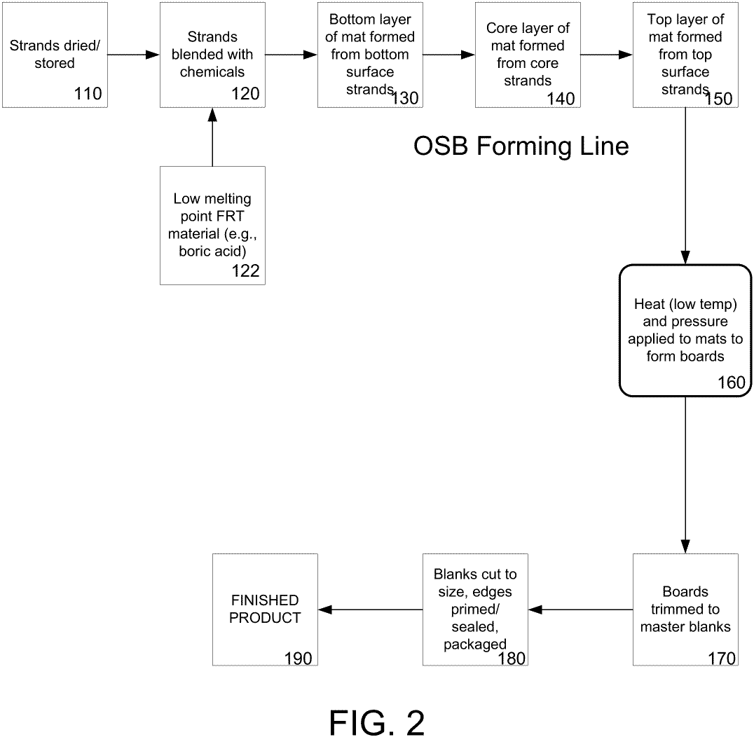

Steps of a manufacturing process in accordance with the present invention using a low temperature press are shown in FIG. 2. These steps include the drying and storing of wood strands 110, the treatment or blending of designated strands (e.g., bottom, core, top, or all strands) with applicable chemicals and/or additives (e.g., wax, resin, and the like) 120, including FR treatment 122 being added to the blending apparatus, the forming of the appropriate layers in order (first bottom surface, then core, then top surface) using designated strands, 130, 140, 150, the application of low press heat and pressure to the mats using a primary press to form boards 160, and subsequent trimming 170 and processing (e.g., panels cut to size, edges primed/sealed, and packaging) 190 to produce the finished product 190. As described above, in this method the press temperature is reduced to a temperature below the melting point of the FR (e.g., boric acid), well below the standard press temperature for OSB. In certain embodiments, the temperature is reduced to approximately 168° C., or to a range of approximately 140° C. to 170° C., more preferably 165° C. to 168° C. Strands for a particular layer typically are blended with applicable chemicals and/or additives in a bin or blender, separate from strands for other layers, although this is not always the case. Additionally, as described above, in some embodiments the treatment 12 is dispersed through the wood substrate, but may be found at higher densities or concentrations in certain layers, or certain areas of a mat, or certain locations within the wood substrate as a whole. In some embodiments, the treatment may be dispersed or spread more uniformly through a mat or the wood substrate as a whole.

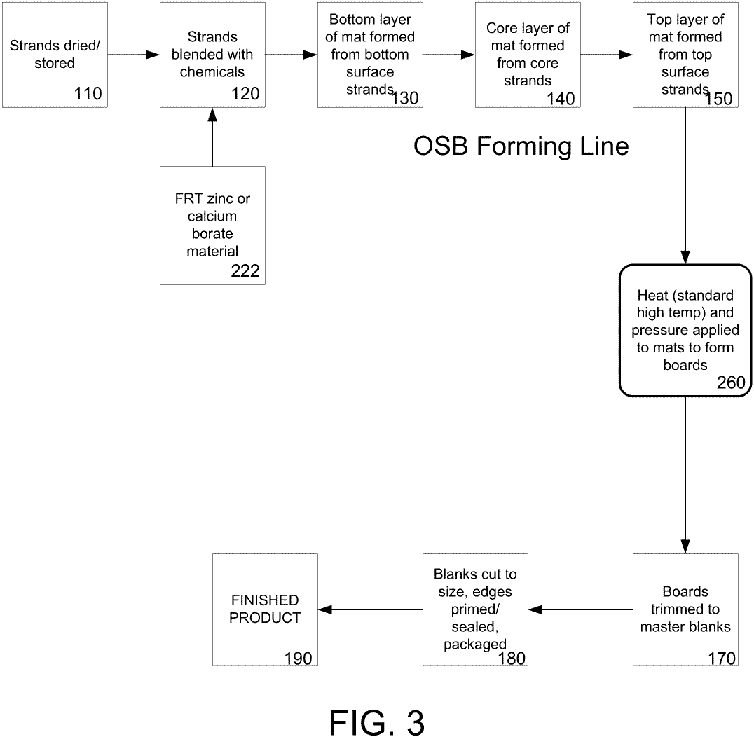

FIG. 3 shows an embodiment of the manufacturing process where higher melting point borate products, such as zinc or calcium borates, are used as the FR treatment 132 that is blended with the wood strands. In this embodiment, standard higher temperature heat and pressure is applied to the mats to form the boards 260.

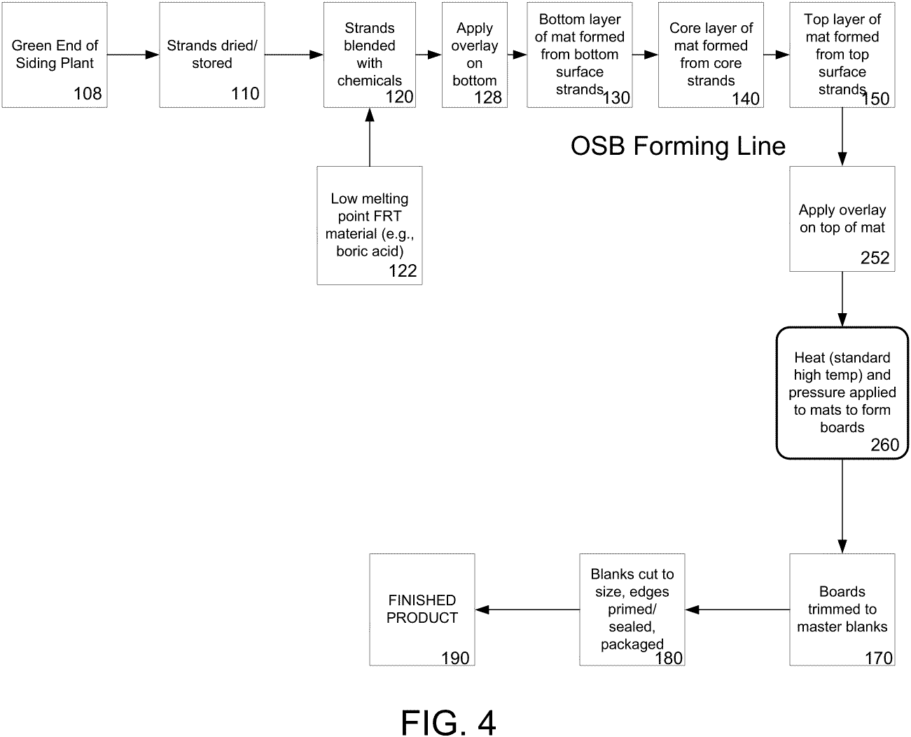

FIG. 4 shows an embodiment of the manufacturing process where lower melting point borate products, such as boric acid 122, are used in combination with a higher (up to the typical or standard) press temperature 260. In this embodiment, one or more sheets of overlay paper 30, 32 are placed on the bottom 128 and/or top 252 of the mat before the mat and paper overlay are pressed to form a FRT composite panel of the present invention. This arrangement keeps the low melting point material from building up in the press. The paper overlay may comprise a resin-impregnated overlay. In addition to the overlay, or as substitute therefor, a release agent is applied to the top surface of the mat, and to the bottom screen or plate, prior to entering the press. The use of the release agent will allow raising the press temperature slightly above the melting/softening temperature of the fire retardant, while preventing sticking. For example, with the release agent, when a boric-acid-based fire retardant is used, the press temperature can be set at 175 ⁰C, slightly above the melting point of boric acid.

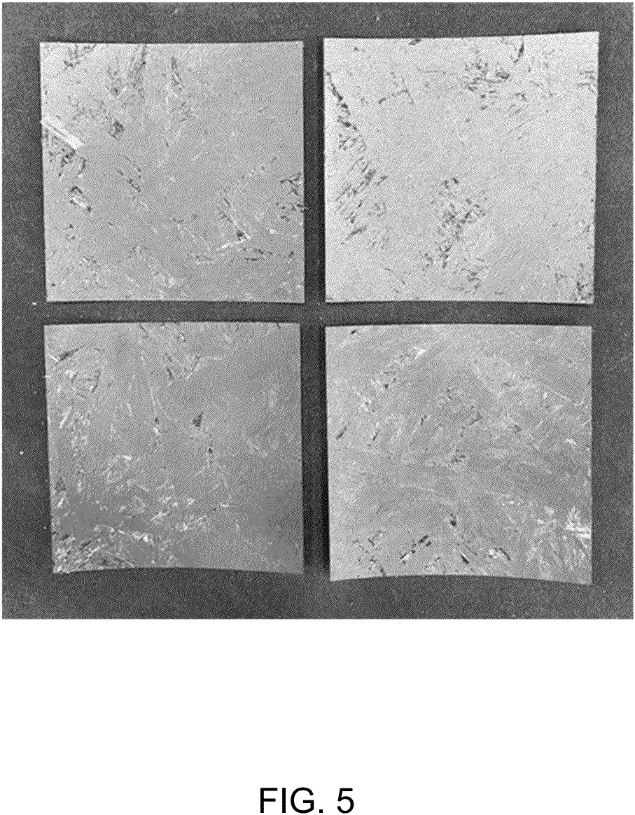

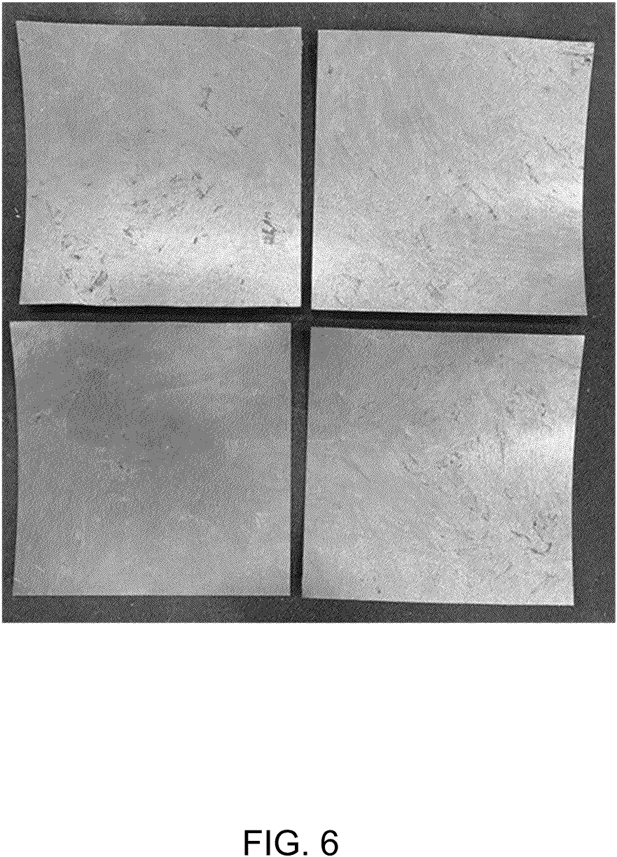

FIG. 5 shows an example of wood fiber and fire-retardant buildup (on steel shims place on top of an OSB mat), with the OSB mat being pressed at 212° C. FIG. 6 shows a lack of wood fiber and fire-retardant buildup on similar steel shims for an OSB mat being pressed in accordance with the low-temperature press method of the present invention.

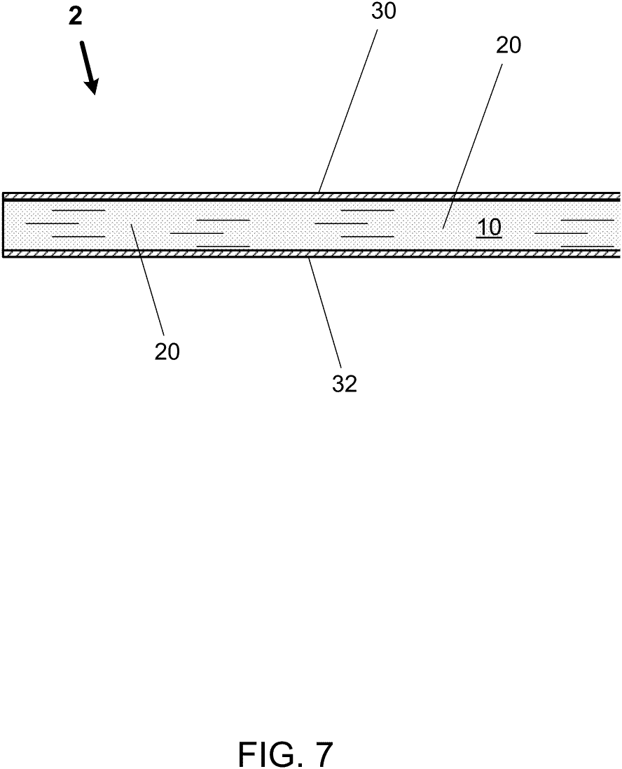

FIG. 7 shows a cross-section of an alternative embodiment of fire-resistant treated (FRT) panel with overlays (upper 30 and lower 32) in accordance with the method of FIG. 4.

In various embodiments, the FR treatment gives the FRT panel product Fire Resistant (FR) characteristics (for use in a fire-resistance-rated assemblies, or where FRT wood is required by building codes).

A large dosage of FR, e.g., 10-20% based on the weight of wood, is typically necessary to meet the code requirements for wood structural panels. To effectively distribute the FR to individual strands, FR may be added in various stages of the process, such as wet bin outfeed, dry bin outfeed, blender infeed, or directly inside blender etc. An alternative approach would be to install a second set of blenders with the sole purpose of adding the FR treatment to the strands, and then these treated strands are subsequently processed through the normal blending processes to add the resin/wax needed for OSB production. This approach would allow for specific modifications to blending variables (i.e., speed, angle, RPM, spray nozzles, etc.) to ensure a more complete application and absorption of the FR treatment. This approach would also further reduce blender build-up, and reduce the potential interference of the FR treatment with proper resin/wax blending.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method for producing a fire-retardant treated wood composite panel without fire-retardant build-up, comprising the steps of:
treating wood strands with a fire-retardant with a melting point;
forming one or more layers of a strand mat with said fire-retardant treated wood strands;
applying pressure and heat by a press at a press temperature to the strand mat to form a wood composite board; and
processing the wood composite board to form one or more fire-retardant treated composite wood panels;
wherein the fire-retardant and press temperature are selected to reduce and/or eliminate build-up of the fire-retardant on the press.

2. The method of claim 1, wherein the fire-retardant and press temperature are selected so that the melting point of the fire-retardant is above the press temperature.

3. The method of claim 1, wherein the fire-retardant comprises boric acid and the press temperature is equal to or no more than approximately 168° C.

4. The method of claim 1, wherein the press temperature is approximately 168° C.

5. The method of claim 1, wherein the press temperature is approximately 150° C. to approximately 170° C.

6. The method of claim 1, wherein the fire-retardant comprises zinc borate and the press temperature is equal to or no more than approximately 220° C.

7. The method of claim 1, wherein the fire-retardant comprises calcium borate and the press temperature is equal to or no more than approximately 220° C.

8. The method of claim 1, wherein the fire-retardant is applied in an amount of approximately 10% to approximately 20% of the weight of the wood strands.

9. The method of claim 1, wherein the wood strands are treated with fire-retardant by applying fire-retardant one or more points in the strand treatment process.

10. The method of claim 9, wherein the fire-retardant is applied at one or more of the following points in the strand treatment process: wet bind outfeed; dry bin outfeed; blender infeed; and inside the blender.

11. The method of claim 1, wherein the strand mat comprises two or more layers, and at least one of the two or more layers is treated with fire-retardant.

12. The method of claim 10, wherein the strand mat comprises two or more layers, and at least one of the two or more layers is treated with a different amount of fire-retardant than other layers.

13. The method of claim 1, further comprising the step of applying an overlay to a top surface of the strand mat and/or a bottom surface of the strand mat prior to the step of applying pressure and heat.

14. The method of claim 1, further comprising the step of applying a release agent to a top surface of the strand mat and/or a bottom screen or plate prior to the step of applying pressure and heat.

15. The method of claim 1, wherein the press temperature is approximately 175° C.

16. The method of claim 1, further comprising the step of applying a fast-cure adhesive to the wood strands with a catalyst or accelerator prior to forming one or more layers of the strand mat.

17. A fire-resistant treated composite wood product produced by method 1.
